(19) United States
(12) Patent Application Publication
(10) Pub. No.: US 2013/0094812 A1
(43) Pub. Date: Apr. 18, 2013

(54) Conduit Tube Assembly and Manufacturing Method for Subterranean Use

(71) Applicant: Carl W. Stoesz, Christiansburg, VA (US)

(72) Inventor: Carl W. Stoesz, Christiansburg, VA (US)

(73) Assignee: Baker Hughes Incorporated, Houston, TX (US)

(21) Appl. No.: 13/271,998

(22) Filed: Oct. 12, 2011

(51) Int. Cl. F16L 3/00; G02B 6/36

(52) U.S. Cl. 385/76; 248/49

(57) ABSTRACT

A support system for fiber optic cable adjacent a bottom hole assembly is fabricated from flat sheet that has a capillary tube attached with the assembly spirally wound into a tube shape and the spiral seal being welded. Male and female end connections that comprise timed threads are then oriented at each tube end with respect to where the capillary tube terminates so that there will be a reduced or no misalignment of fiber optic cable ends when timed threads are fully made up. A predetermined tightening torque range also allows some fine tuning of the desired alignment to reduce any offset of fiber optic cable ends. The capillary can run inside or outside the assembled tube shape.

### FIELD OF THE INVENTION

The field of the invention is multi-component structures and related manufacturing methods that support one or more conduits that can hold, among other things, one or more fiber optic cables adjacent to a bottom hole assembly for the purpose of communication or storage of information locally or to a remote location.

### BACKGROUND OF THE INVENTION

FIG. 1 illustrates a known technique and is illustrative in showing the issues that are confronted when using the assembly shown there. What is schematically illustrated in FIG. 1 is a single tubular 10 that can be part of a string such as a screen assembly. In the tubular 10 the screen is disposed under a tube 12 that has centralizers 14 and 16 shown at ends 18 and 20. The tube 12 is made of flat sheet that has a tube 21 attached to it on the inside and then the flat sheet is rolled spirally to make a spiral seam 22 that is butt welded. Broken lines 24 indicate that the bulk of the length of the tubular 10 is the screen section covered by the tube 12.

Fiber optic segments 26 and 28 extend from opposed ends of the tube 12 and respectively terminate in connectors 30 and 32. After another joint is connected to male threads 34 a jumper 36 that has at its end a half 38 of what is known as a dry mate connection is attached to a mating half connection that is not shown. At the other end there is a long blank segment 40 of the tubular 10 around which there are windings 42 that extend from the connector 30 to allow there to be enough slack in the cable segment 44 so that if there is circumferential misalignment as between the half 38 shown on the left end of the FIG. and the mating half on the adjacent tubular that is threaded to the coupling 46, there will be enough slack to get the halves aligned and joined such as with a surrounding coupling nut so that the fiber optic cable can have continuity. The problem with such a design is that the space needed for windings 42 represents blank pipe on the tubular 10 rather than screen surface. Long blank spots mean poor gravel distribution as the fluid carrying the gravel cannot get through a screen at that location and leave a dense pack of gravel behind that is desirable.

Relevant art to this field are the following references: U.S. Pat. Nos. 6,955,218; 6,513,599; 6,789,621; 7,191,832; 7,792,405; US 2009/0252463; US 2008/271926 and WO2010/025159. Also relevant is U.S. application Ser. No. 12/830,768 filed Jul. 6, 2010.

The present invention addresses the problems described above. One way it does this is to interconnect the tubes with threaded end connections, where the end connections can be attached after the tube and the conduit are fabricated so that at the end of the threading process of adjacent segments and applying a torque in a recommended range the result will be that ends of the fiber optic are sufficiently aligned so that coils of slack 42 are not needed.

Traditionally, control of rotational alignment between threaded connections is accomplished in the machining process using a costly technique commonly referred to as timed threads. In this process the thread cutting tool is started at a specific location on the part. Thus, when two such timed threads are screwed together within a specified torque range consistent relative rotational alignment of the connection is achieved. The present invention avoids the cost of cutting timed threads yet achieves the same result. This is accomplished by using a jig that properly aligns parts 58 and 60 starting location relative to the tube ends 54 and 56 prior to welding 66 and 68.

Elimination of coils 42 allows more of a length of tubing to have screen on it so that the resulting gravel pack is more effective while still leaving the fiber optic in position to collect data on well conditions adjacent the screen. The tubes form an interconnected network about the screen assembly and the assembly is retained against shifting relative to the screen segments that are surrounded with the threaded segments that have a capillary tube in which the fiber optic is located. These and other features will become more apparent to those skilled in the art from a review of the detailed description of the preferred embodiment and the associated drawings while recognizing that the full scope of the invention is to be determined from the appended claims.

This invention also provides the ability of the tubular structure 50 to be situated interior to a supporting structure, such as in FIG. 5, or exterior to a supporting structure as shown in FIG. 7. By means of example in FIG. 5 it is seen that tubular structure 50 is deployed interior to casing 88. A likewise example is shown in FIG. 7 where it can be seen that supporting casing 88 is interior to the tubular structure 50. Not shown in FIGS. 5 and 7 is that tubular structure 50 is affixed to casing 88 in some manner such as a triple connection bushing. In both cases protection to dry mate connection 76 can be achieved by protection bars 78 and 80 or other means such as protection clamps commonly used downhole.

### SUMMARY OF THE INVENTION

A support system for fiber optic cable adjacent a bottom hole assembly is fabricated from flat sheet that has a capillary tube attached with the assembly spirally wound into a tube shape and the spiral seal being welded. Male and female end connections that comprise timed threads are then oriented at each tube end with respect to where the capillary tube terminates so that there will be a reduced or no misalignment of fiber optic cable ends when timed threads are fully made up. A predetermined tightening torque range also allows some fine tuning of the desired alignment to reduce any offset of fiber optic cable ends. The capillary can run inside or outside the assembled tube shape.

### BRIEF DESCRIPTION OF THE DRAWINGS

FIG. 1 is an assembly of a prior art design showing the coiled fiber optic over blank pipe that was used to deal with cable end misalignments;

FIG. 2 shows an assembly of the present invention with timed thread end connections to join ends of tubes that support at least one capillary for a fiber optic cable;

FIG. 3 is a closer view of the left end of FIG. 2;

FIG. 4 is a closer view of the right end of FIG. 2;

FIG. 5 shows an externally wrapped capillary over several connected joints;

FIG. 6 is a section through the capillary of FIG. 5;

FIG. 7 shows an internally wrapped capillary and external cable connections at the joints.

### DETAILED DESCRIPTION OF THE PREFERRED EMBODIMENT

FIG. 2 illustrates a tubular structure 50 preferably made from flat sheet that is rolled with a spiral seam into a tube shape. The seam is butted or overlapped and welded, preferably continuously. A straight seam is also contemplated. At least one capillary tube 52 acting as a transport conduit is preferably spirally wound on the outer surface of the tubular structure 50 and has ends 54 and 56. The position of the ends 54 and 56 is arbitrarily selected and is illustrated at the 12 o'clock position for end 54 and the 9 o'clock position for end 56. A box end 58 with timed threads 60 is attached at end 66 while a pin end 60 with timed threads 64 is attached at end 68. Before the attachment, preferably by welding, the ends 54 and 56 are oriented with respect to the location of the 54 and 56 so that when adjacent tubular structures 50 are assembled an end 54 as shown in FIG. 2 will wind up being within a 90 degree or less offset from a nearby end 56 on an adjacent tubular section 50. A tightening torque is specified so that some fine tuning of any misalignment can take place within the torque range. The tubular sections 50 are modular and after assembly to each other are slipped over a base pipe that supports a bottom hole assembly and secured against axial or rotational movement with respect to the base pipe. In the preferred embodiment the base pipe comprises connected joints of pipe that are part of a screen assembly but other applications where data of well conditions needs to be collected and sent or stored in real time using fiber optic or other elongated conveyances such as wire or pressurized tube, for example, are also contemplated for the assembly of the modular tubular sections 50.

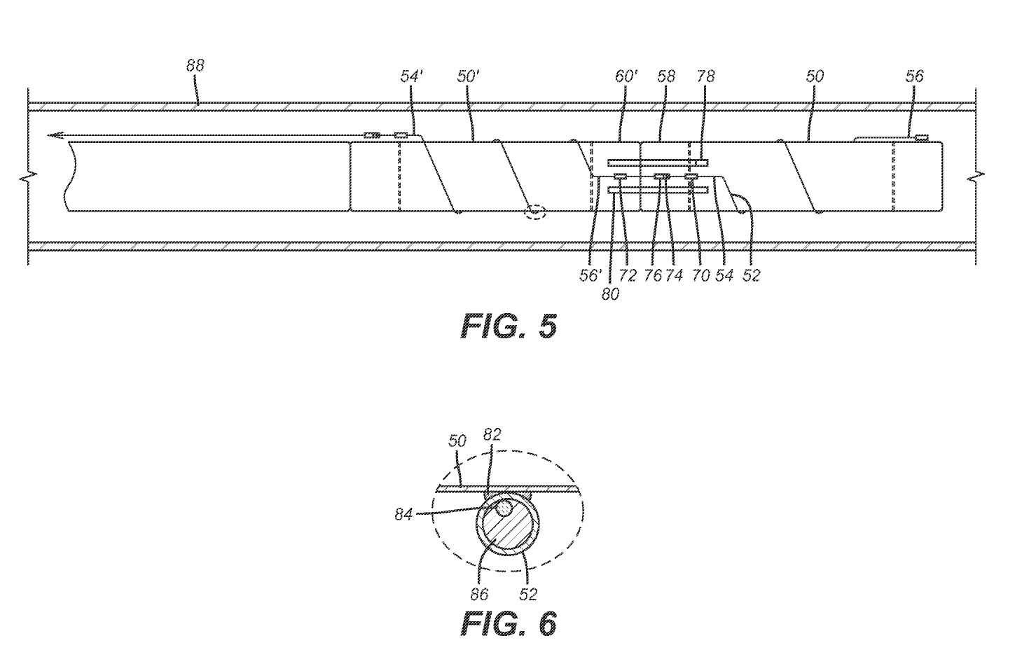

The end alignment described above is better seen in FIG. 5. Tubular segments 50 and 50′ are attached with box end 58 secured to a pin end 60′ on segment 50′. End 54 is aligned with end 56′ when the pin and box are secured within the specified torque range. The fiber optic cable that defines end 54 that extends from capillary 52 has a cable terminal fitting 70. Similarly end 56′ has a terminal fitting 72. Fittings 70 and 72 are respectively connected with a short run of fiber optic to a connector half 74 or 76. Protruding members 78 and 80 straddle the halves and fittings to protect them during run in and tripping out of the hole. Note that despite the circumferential offset between ends 56′ and 54 there is still alignment or near alignment adjacent the made up timed thread pairs as illustrated in two locations in FIG. 5.

FIG. 6 shows the tubular structure 50 with the capillary 52 welded at 82. The fiber optic 84 is inside the capillary 52 and the filling for capillary 52 is an adhesive 86.

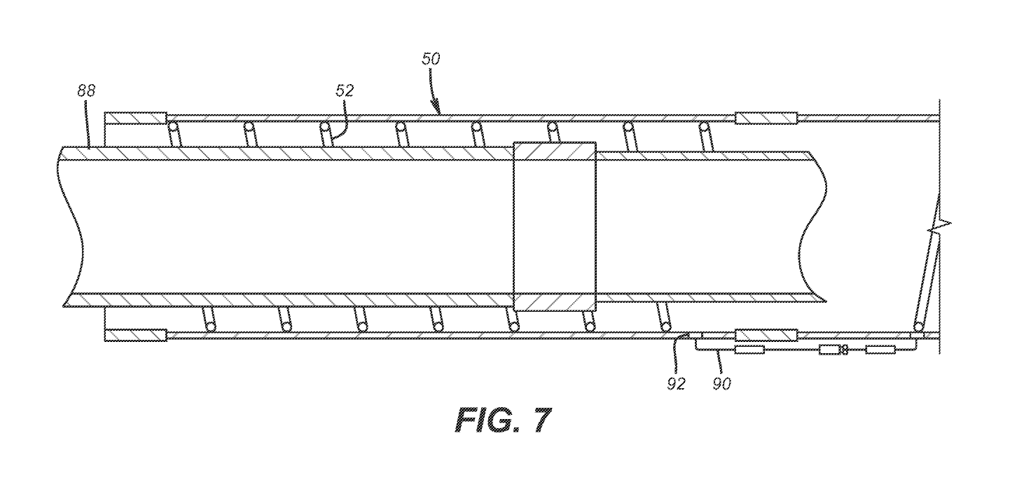

FIG. 7 shows that the tubular 88 that supports the bottom hole assembly is an independent structure from the assembly of tubular structures 50. In FIG. 7 the capillary 52 is inside the structure 50 and is spirally wound. The ends such as 90 emerge from a respective opening 92. The connection over the pair of timed threads is the same as described above.

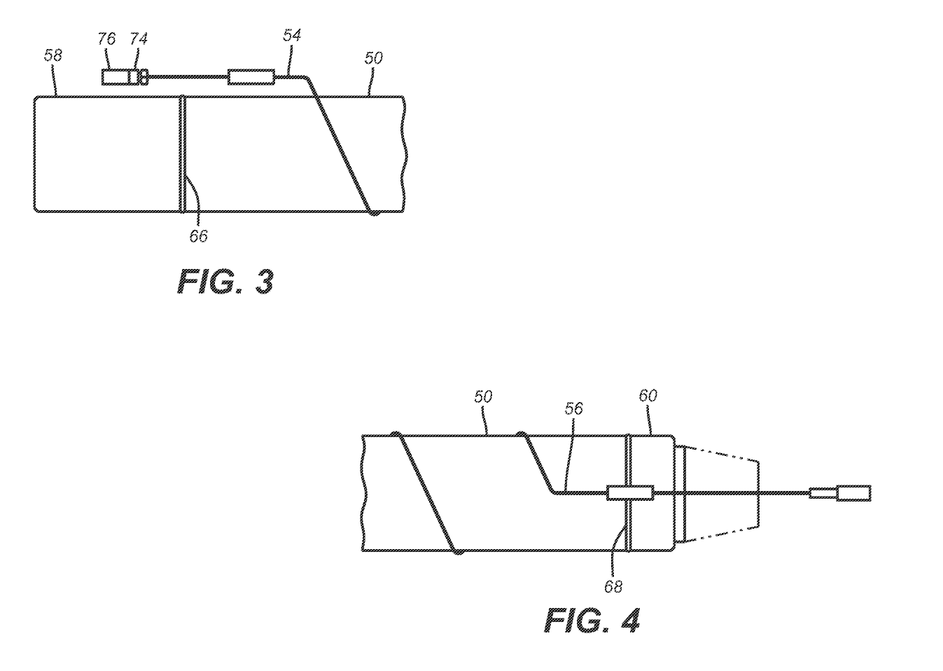

FIGS. 3 and 4 show that the connection halves such as 74 and 76 are axially offset from ends 66 and 68 of the tubular structure 50. Note that despite the circumferential misalignment of ends 54 and 56 that those ends still wind up aligned to a connector half from an adjacent tubular section due to the presence of the timed threads and their initial orientation before such end with timed threads wound up welded to the ends of the tubular structure on assembly.

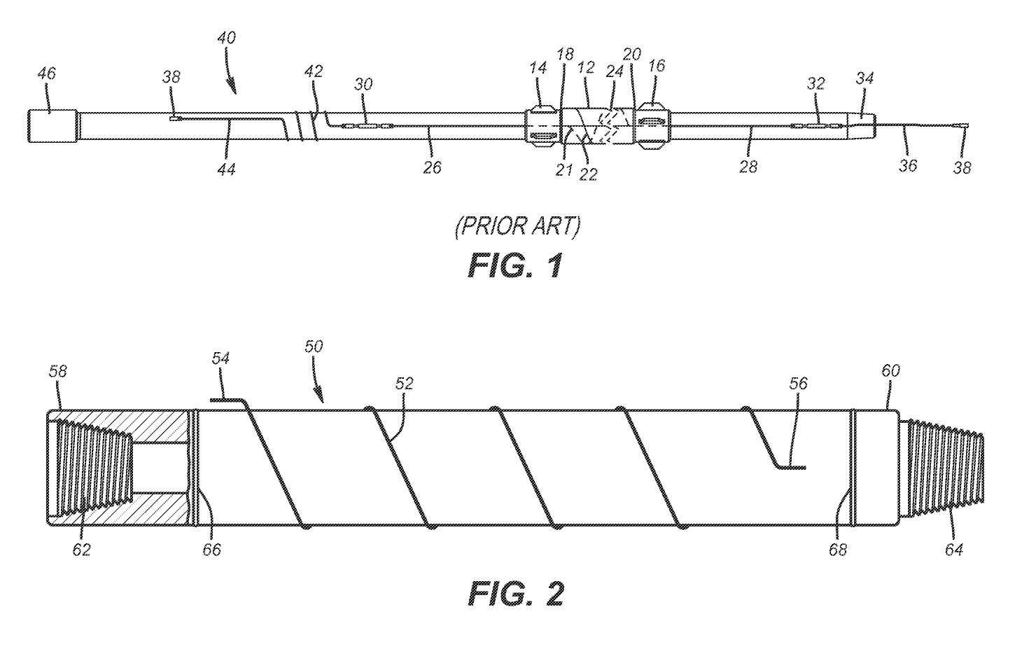

The present invention differs from past designs such as shown in FIG. 1 in that there are no longer discrete sections of tube mounted to a respective section of tubular string to support the fiber optic. Instead sections are joined to each other and slipped over the tubular string and then secured to it against relative movement. The outer assembly of tubes with the capillary inside or outside has capillary ends that line up due to timed thread ends that are oriented before attachment so that capillary ends will come within a target of 90 degrees of offset or less. The tightening torque specification range allows more fine tuning to reduce or eliminate the offset. External centralizers or other protruding structures protect the fiber optic connections which are preferably axially offset from the pin or box connections on the ends of each tubular component. The tubular components can be made from a flat sheet that is spirally wrapped and seam welded to put the capillary on the inside or the outside of the finished tube.

The above description is illustrative of the preferred embodiment and many modifications may be made by those skilled in the art without departing from the invention whose scope is to be determined from the literal and equivalent scope of the claims below:

I claim:

1. A modular assembly for support of an elongated data communication device from a tubular string supporting a bottom hole assembly, comprising:
at least two tubular housings having opposed ends and adapted to be supported by the tubular string;
at least one transport conduit mounted to each said tubular housings and extending the substantial length thereof with conduit ends terminating adjacent said opposed ends of said tubular housing to which said transport conduit is mounted;
said ends of said tubular housings comprising end connections to allow said tubular housings to connect to each other such that a data communication device can be extended through said transport conduits on said tubular housings.

2. The assembly of claim 1, wherein:
said end connections are configured to control circumferential offset between transport conduits on adjacent tubular housings to a predetermined value.

3. The assembly of claim 2, wherein:
said predetermined value can be altered by using different assembly torque values within a predetermined torque range.

4. The assembly of claim 2, wherein:
said end connections comprise timed threads.

5. The assembly of claim 4, wherein:
said end connections are marked for the start of said timed thread and said mark is oriented a predetermined offset from an adjacent end of a transport conduit.

6. The assembly of claim 1, wherein:
said transport conduit is mounted to an exterior surface of said tubular housing.

7. The assembly of claim 1, wherein:
said transport conduit is mounted to an interior surface of said tubular housing and further comprises ends that extend through respective openings in said tubular housing.

8. The assembly of claim 1, wherein:
said transport conduits have a gap between adjacent tubular housings.

9. The assembly of claim 8, wherein:
said transport conduits are spirally wound around said tubular housing.

10. The assembly of claim 1, wherein:
said tubular housing is formed from a flat sheet with said transport conduit attached thereto and then rolled into a tubular shape with a seam.

11. The assembly of claim 10, wherein:
said seam is spirally shaped.

12. The assembly of claim 10, wherein:
said seam is straight.

13. The assembly of claim 8, wherein:
said assembly further comprises a fiber optic cable extending through said transport conduits and bridging said gap.

14. The assembly of claim 13, further comprising:
a connector for said fiber optic cable located in an axially offset location from surfaces that contact when said end connections of adjacent tubular housings make contact.

15. The assembly of claim 13, wherein:
a connector for said fiber optic cable;
at least one exterior projection on at least one said tubular housing and adjacent said connector.

16. The assembly of claim 16, wherein:
said at least one exterior projection comprises a pair of substantially parallel projections that span over said end connections that join adjacent tubular housings.

17. The assembly of claim 13, wherein:
said transport conduits further contain adhesive for fixation of said fiber optic.

18. The assembly of claim 1, wherein:
one end of a transport conduit is circumferentially offset from an opposed end of said transport conduit on a single tubular housing.

19. The assembly of claim 1, wherein:
said tubular housings are loosely fitted within the tubular string.

20. The assembly of claim 1, wherein:
said tubular housings are loosely fitted outside said tubular string.

21. The assembly of claim 2, wherein:
said end connections comprise a thread whose start point is positioned at a predetermined circumferential location with respect to an adjacent transport conduit end before fixation to said tubular housing so that assembly of said tubular housings to each other using said threads results in circumferential alignment of adjacent ends of transport conduits on adjacent tubular housings within a predetermined limit.
